(19) United States
(12) Patent Application Publication
(10) Pub. No.: US 2015/0086267 A1
(43) Pub. Date: Mar. 26, 2015

(54) REINFORCEMENT DEVICE FOR IMPROVING THE BEHAVIOR OF AT LEAST A PORTION OF A COMPOSITE PART

(71) Applicant: SKF AEROSPACE FRANCE, Saint-Vallier (FR)

(72) Inventor: Guy Valembois, Lauzerville (FR)

(21) Appl. No.: 14/395,886

(22) PCT Filed: Apr. 24, 2013
(86) PCT No.: PCT/FR13/50913

§ 371 Date: Oct. 21, 2014

(30) Foreign Application Priority Data
Apr. 24, 2012 (FR) 1253773

(51) Int. Cl. F16B 21/12

(52) U.S. Cl. CPC F16B 21/12
USPC 403/404

(57) ABSTRACT

The device, for reinforcing the area of a part that serves to transmit force, includes two elements for clamping the part. The part can be made of a composite material with reinforcement fibers embedded in a resin. The force transmitted is in the drape-forming plane of the reinforcement fibers of the part. The two elements are at a portion of the part, and at least one linking body connects the two elements with pre-stress so as to generate compression at the portion. At least one linking body is secured to another part with a view to transmitting force.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates, in the field of the parts made of composite material comprised of reinforcing fibers embedded in a resin, to a reinforcing device for improving the behavior of at least a portion of a part when the latter is subjected to a stress due to the transmission of a force, and in particular at the level of the area serving for said transmission, and when said force is located in the drape-forming plane of the reinforcing fibers said part includes.

2. Description of Related Art Including Information Disclosed Under 37 CFR 1.97 and 37 CFR 1.98.

Usually, a part made of composite material is formed of a superposition of composite layers each comprising reinforcing fibers embedded in a thermoplastic or thermosetting matrix, commonly referred to as resin. The orientation of the fibers is preferably chosen depending on the direction of the stress of the part, while the shape of the parts results from the molding.

Some parts have portions forming between them an angle resulting from the molding, and these fibers the parts are comprised of follow the same angulation. In FIG. 1 is shown the portion of such a composite part forming an angle, and comprised of layers of fibers 10 embedded in a resin 11. When the part 1 is subjected to a force B in unfolding, this generates an axial traction S of the fibers 10 on the inner side of the angle K and an axial compression of the fibers 10 on the outer side, resulting into stressing the resin 11, which bonds the layers of fibers 10, and hence into a risk of delamination.

A similar drawback is found in the case of a part made of composite material associated with another part through a connection for the transmission of a force. Such a part can, non-restrictively, consist of a connecting rod or the like, obtained by the superposition of composite layers, and including at each of its ends a bore forming the eyelet aimed at making the connection with another part, said bore having preferably an axis perpendicular to the planes of said layers.

In FIG. 2 is shown such a connecting rod 2, which includes two bores 20, one at each of its ends, in order to permit to make a connection with another part, not shown, such that said connecting rod 2 is stressed in traction or compression in a direction parallel to the planes of the layers the connecting rod 2 is formed of.

When there exists a break due to the transmission of a force, one observes that the break occurs at the level of the interface areas.

In FIGS. 3a and 3b, which show cross-sectional views along a median longitudinal plane of the connecting rod 2 at the level of a bore 20, one can see that the failure mode is as follows: the local matting at the level of the bore 20 produces a compression C in the radial direction of the bore 20, i.e. directly in the direction of the composite layers. This compression C induces a traction T in the direction orthogonal, i.e. perpendicular, to the composite layers. The resin thus directly supports this tensile stress S. The presence of composite fiber does not assist at all the local resistance to this tensile stress of the resin, which leads to a delamination D of the composite layers.

This delamination causes the local buckling of the composite fibers, which are stressed in local compression, causing the failure of the part.

It should be noted that it is possible to provide the bore 10 internally with an insert, which consists of an element, for example made of metal, this does however not change the mode of failure because the insert does not change the local balance of the stresses.

In order to cope with all the above drawbacks, it is possible to use the sewing technique, which consists in carrying out, at the level of namely the areas likely to be stressed, an interleaving of reinforcing fibers passing perpendicularly through the superposition of layers, such as to contain an eventual separation of said layers.

This technique has however limitations, because the compression is only local and therefore introduces stress concentrations, which induce an inhomogeneous compression, leaving areas in compressive under-load, thus likely to have a beginning of delamination likely to cause the failure of the part.

### SUMMARY OF THE INVENTION

The aim of the present invention is to provide, in the field of the composite parts aimed at being subjected to the transmission of a force, a device for reinforcing the area serving for the transmission of said force.

The device for reinforcing the area serving for the transmission of a force of a part made of composite material formed of reinforcing fibers embedded in a resin, when said force is located in the drape-forming plane of the reinforcing fibers said part according to the invention includes is essentially characterized in that it comprises, on the one hand, two elements aimed at clamping said composite part at the level of said area or in the vicinity thereof and, on the other hand, at least one linking body, which connects said two clamping elements with a pre-stress, such as to generate a compression at the level of said portion, and in that at least one of said linking bodies is designed capable of permitting its making integral with another part for the transmission of a force.

The reinforcing device permits a compression of the portion of the composite part aimed at being stressed, i.e. to pre-stress the resin, which increases the strength of the part.

According to an additional feature of the reinforcing device according to the invention, the linking body passes through the layers perpendicularly to the planes thereof, in order to connect the clamping elements.

According to another additional feature of the reinforcing device of the invention, it includes several evenly distributed linking bodies.

The multiplication of the linking bodies and their distribution permit the homogenization of the compression of the enclosed part, which increases the mechanical strength of the composite part.

According to a particular embodiment of the reinforcing device according to the invention, the clamping elements consist of plates pierced with holes permitting the passing through of linking bodies, which consist of clamping means.

The clamping means may consist of wire elements passing through the holes of the plates by passing through the composite material in the way of a seam, or screws, rivets, etc . . .

According to a particular embodiment of the reinforcing device according to the invention, the linking body protrudes outwardly beyond the two clamping elements, such as to form coupling points for the transmission of a force.

According to another additional features of the reinforcing device of the invention, the linking body is tubular, such that a means for fastening to another part can axially pass through it, for the transmission of the force.

A blocking of the transverse displacement under the force entering into the composite part is obtained. The local compression is transformed by the action of the blocking in perpendicular compression at the composite layers due to the POISSON effects. The strength of the resin is consolidated, because it works in a mode closer to the hydrostatic compression.

According to an additional feature of the reinforcing device according to the invention, the two clamping elements are fastened to the tubular body through assembling means capable of ensuring a resistance to the axial forces, which tend to separate said two clamping elements.

According to another additional feature of the reinforcement device according to the invention, the assembling means consists of a means for assembling by snapping-on, by riveting, by soldering or by gluing.

According to another additional feature of the reinforcing device according to the invention, the assembling means consists of a means for assembling by screwing.

According to a particular embodiment of the reinforcing device according to the invention, the two clamping elements consist of washers.

According to a preferred embodiment of the reinforcing device according to the invention, the tubular body includes at each of its ends, or close to them, an external thread, while the bore of each of the washers has an internal thread.

The mounting of the reinforcement device according to the invention occurs on the composite part by tightening the washers. This tightening guarantees a favorable pre-stress for the compression of the composite layers.

Advantageously, a gluing performed simultaneously with the screwing permits to consolidate the whole, while avoiding a loosening of the washers.

Also advantageously, the washers include externally imprints permitting their gripping using a clamping tool.

It should be noted that in an induced way, the reinforcing device according to the invention has the advantage of protecting the area of the composite part against the impact likely to reduce its level of performance.

The present application also relates to a part made of composite material formed of reinforcing fibers embedded in a resin, and at least one portion of which is provided with a reinforcing device as defined above.

The aim of the invention is in particular to improve the strength of a composite part when it is used for the transmission of an effort, and in particular at the level of the area serving for said transmission, and namely when said effort is located in the drape-forming plane of the reinforcing fibers said part includes.

The advantages and features of the reinforcing device according to the invention will become clear from the following description, which refers to the attached drawing, which shows a non-restrictive embodiment of same.

### BRIEF DESCRIPTION OF THE DRAWINGS

FIG. 1 represents a schematic partial view showing the stress on a composite part.

FIG. 2 represents a schematic perspective view of a composite part likely to receive reinforcing devices according to the invention.

FIGS. 3a and 3b represent partial cross-sectional views along a median longitudinal plane of the composite part of FIG. 1.

FIG. 4 represents a schematic perspective view of a particular embodiment of the reinforcing device according to the invention.

FIG. 5 represents a schematic cross-sectional view along a median axial plane, and an exploded view of the same particular embodiment of the reinforcing device according to the invention.

FIG. 6 represents a schematic partial cross-sectional view along a longitudinal median plane of the composite part of FIG. 1 provided with the reinforcing device according to the invention.

FIG. 7 represents the same schematic view of the composite part provided with a variant of the reinforcing device according to the invention.

FIG. 8 represents a schematic perspective view of the composite part of FIG. 1 provided with reinforcing devices according to the invention.

FIG. 9 represents a schematic perspective view of another composite part provided with a reinforcing device according to the invention.

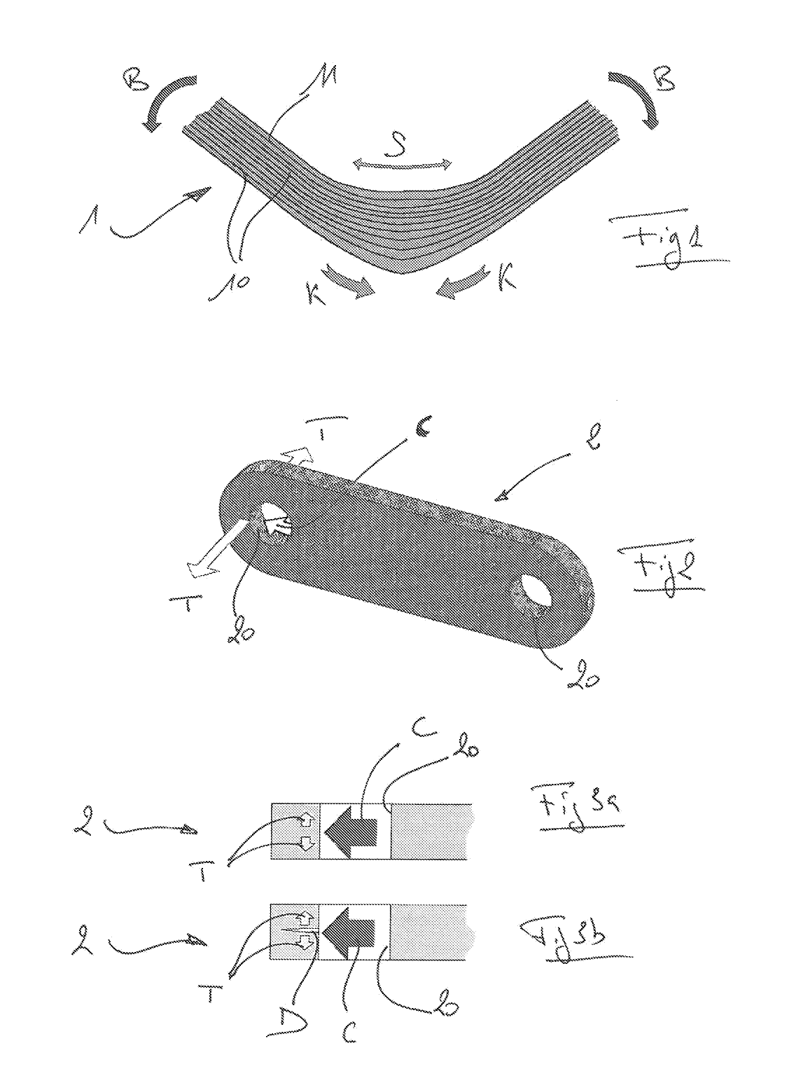

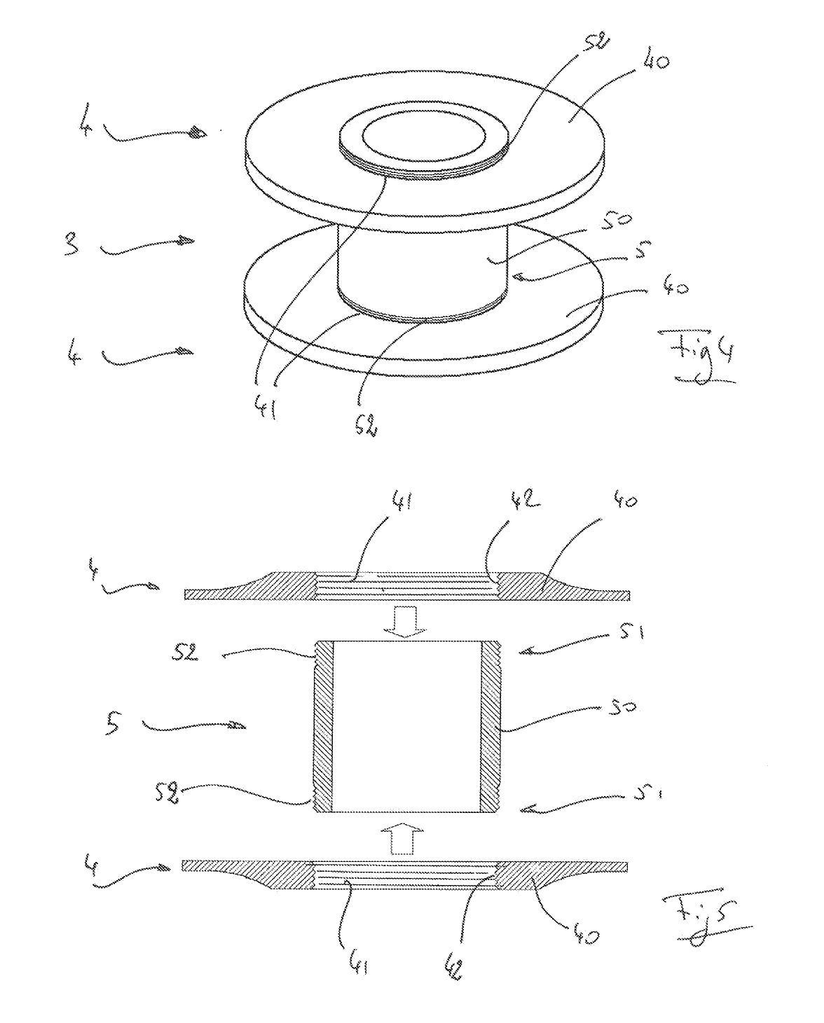

### DETAILED DESCRIPTION OF THE DRAWINGS

When referring to FIGS. 4 and 5, we can see a reinforcing device 3 according to the invention, in a particular embodiment, intended to contribute to the transmission of a force.

This reinforcing device 3 is intended to equip a composite part, such as the connecting rod 2, for example, it includes two clamping elements 4, which consist of washers 40, and a linking body 5, which is in the form of a tube 50. The tube 50 has, at each of its ends 51, an external thread 52, while the bores 41 of the washers 40 include an internal thread 42, not visible in FIG. 4. The assembling of the washers 40 to the tube 50 by screwing provides the reinforcing device 3 with the shape of a coil.

It should be noted that the tube 50 and the washers 40 are preferably made of metal.

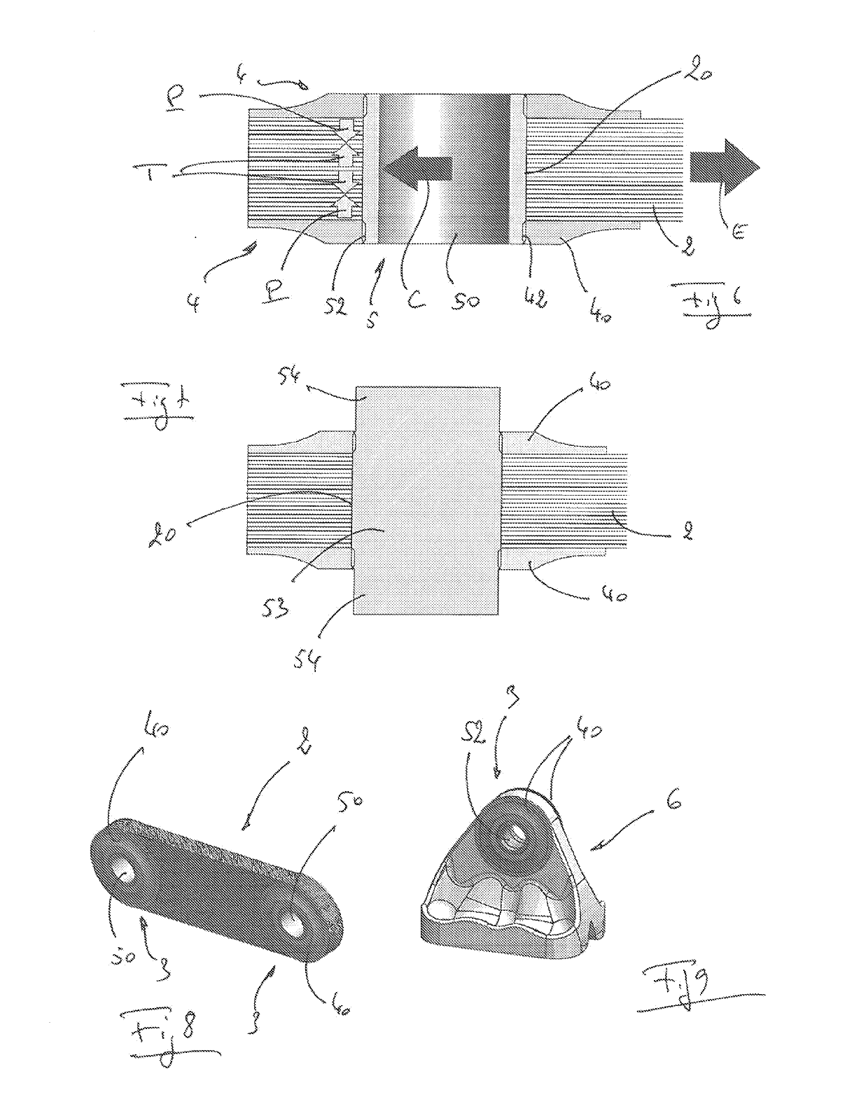

As can be seen in FIG. 6, the tube 50 is intended to be positioned, preferably closely, within the bore 20 of a composite part such as a connecting rod 2, while the washers 40 are intended to be screwed onto the ends of the tube 50 until it presses the connecting rod 2 in the area bordering the bore 20 at the periphery.

It should be noted that the dimensional characteristics of the threaded portions are adapted to permit to perform such a clamping, and that a fine pitch is preferably used.

It can be observed that, when the composite part is subjected to an axial force E, for example through a connecting shaft inserted into the tube 50, the compression C generated by this force E in the tube 50 creates a traction T perpendicular to the layers forming the composite part, which traction T is restricted by the pressure P exerted by the washers 40.

It should be noted that making the washers 40 integral with the tube 50 by a screwing method is not restrictive, because it is possible to use other fastening methods, by snapping-on, crimping, gluing, brazing etc.

When referring now to FIG. 7, we can see a variant in which the tube 50 is replaced by a shaft 53 of a length such that its ends 54 can extend beyond the washers 40, such as to form means for fastening, for example to a platelet, not shown.

When referring to FIGS. 8 and 9, we can see two parts made of composite material, namely respectively a connecting rod 2 and a fitting 6, the bores of which, intended at making a connection with another part, are each provided with a reinforcing device 3 according to the invention, permitting to avoid the delamination of the composite material.

Advantageously, the reinforcing device 3 according to the invention has another advantage, in fact, as can be seen in FIGS. 8 and 9, it is possible to dimension the washers 40 such that they cover the entire force-absorbing area of the composite part, 2 and 6, i.e. up to at least one portion of the outermost edge, thereby permitting to ensure its protection, for example, against impacts.

It should be noted that it is also possible, in order to prevent a delamination of the edge of a composite part, to provide for linking bodies connecting the clamping elements, on the external side of the composite part, preferably into contact with the latter, such as to form for example a gutter, receiving the edge, or at least one portion of the edge, of the composite part.

The present invention permits not only to increase the lifetime of the parts made of composite material, but it also permits to consider reducing the required thickness of composite material and, therefore, despite the weight of the reinforcing devices 3, reducing the overall mass of the part.

1. Device for reinforcing an area for transmission of a force of a part comprised of composite material, said composite material being comprised of reinforcing fibers embedded in a resin, said force being located in a drape-forming plane of said reinforcing fibers, said device comprising:
two elements clamping said part at a level of said area; and
at least one linking body connecting the two elements with a pre-stress, said area having a compression, wherein at least one linking body is made integral with another part for transmission of another force.

2. Reinforcing device, according to claim 1, wherein the linking body passes through layers perpendicular to planes thereof, in order to connect the elements.

3. Reinforcing device, according to claim 1, further comprising several regularly distributed linking bodies.

4. Reinforcing device, according to claim 1, wherein each element comprises plates pierced with holes, at least one linking body passing through said holes, wherein a linking body is comprised of a clamping means.

5. Reinforcing device, according to claim 4, wherein said clamping means comprises wire elements extending through said holes while passing through the composite material in a manner of seam, or screws or rivets.

6. Reinforcing device, according to claim 1, further comprising: a linking body being made integral with another part for the transmission of another force.

7. Reinforcing device, according to claim 6, wherein said linking body protrudes beyond the two elements so as to form coupling points for transmission of said force.

8. Reinforcing device, according to claim 6, wherein said linking body is tubular, said linking body being crossed axially by a means for fastening to another part for transmission of force.

9. Reinforcing device, according to claim 7, wherein the two elements are fastened to the tubular linking body through assembling means ensuring a resistance to axial forces separating the two elements.

10. Reinforcing device, according to claim 9, wherein said assembling means comprises an assembling means by screwing.

11. Reinforcing device, according to claim 9, wherein the two elements are comprised of washers.

12. Reinforcing device, according to claim 11, wherein the linking body comprises an external thread at each end thereof, each washer having a bore with an internal thread.

13. Reinforcing device, according to claim 9, wherein said assembling means comprises an assembling by snapping-on, by riveting, by soldering or by gluing-snapping-on.

14. Part comprised of a composite material, said composite material being comprised of reinforcing fibers embedded in a resin, said part comprising:
at least a portion provided with a reinforcing device according to claim 1.
